(19) United States
(12) Patent Application Publication
(10) Pub. No.: US 2022/0395710 A1
(43) Pub. Date: Dec. 15, 2022

(54) Negative Pressure Respirator Assembly

(71) Applicant: Brandon King, Eagle Mountain, UT (US)

(72) Inventor: Brandon King, Eagle Mountain, UT (US)

(21) Appl. No.: 17/695,660

(22) Filed: Mar. 15, 2022

Related U.S. Application Data
(60) Provisional application No. 63/161,428, filed on Mar. 15, 2021.
(60) Provisional application No. 63/161,443, filed on Mar. 15, 2021.

(51) Int. Cl. A62B 18/02; A62B 23/02; A62B 18/10

(52) U.S. Cl. CPC A62B 18/025; A62B 23/02; A62B 18/10

(57) ABSTRACT

A negative pressure respirator assembly may have an exchangeable filter elements, at least one intake valve, a facepiece body comprising a headband and a face shield, an outflow valve, an outflow tube coupled to the outflow valve, the outflow tube directing exhaust in at least one direction selected from the group consisting of parallel to the user's torso and down the user's shirt, into the user's personal protective equipment, and over the user's shoulder.

### CROSS-REFERENCE TO RELATED APPLICATION

This current application claims the benefit of and incorporates by reference the following two provisional applications: Ser. No. 63/161,428, filed on Mar. 15, 2022, and Ser. No. 63/161,443, filed on Mar. 15, 2022.

### BACKGROUND OF THE INVENTION

Negative pressure mask respirators are a type of respiratory Personal Protective Equipment (PPE) widely used by workers in industries with an element of risk or danger, such as the industrial, construction, mining, and defense industries, to protect themselves in environments where the air is contaminated, harmful or uncomfortable for breathing. However, negative pressure respirators are not currently used widely in health care.

Negative pressure mask respirators are available in half-masks, that cover the nose and mouth, and full-masks, which have a clear lens that covers the eyes as well as the nose and mouth. Negative pressure respirators use exchangeable filter elements (cartridges or filters) that may be selected to provide the needed protection. The facepieces may be made of synthetic or natural rubber material that allow repeated cleaning, disinfection, storage, and reuse.

Negative pressure masks respirators require a tight seal against the user's face, and a functioning inflow and outflow valves in order to be safe for the user. When the user inhales it creates a negative pressure within the mask, pulling environmental air through the filter elements and inflow valve(s) into the mask. When the user exhales, it creates a positive pressure within the mask, thereby closing the inflow valve(s) and opening the outflow valve, which results in an emission of the user's respiratory droplets and aerosols onto the work area or patient below.

A negative pressure mask respirator that is available at https://www.remm.nlm.gov/respiratory_ppe.htm on Mar. 9, 2021 is incorporated by reference; the negative pressure masks respirators may be reusable, elastomeric, half mask or full mask, and may be used to provide a negative-pressure environment around a user's nose and mouth. The negative pressure mask respirator may be reusable and may have an elastic facepiece that may be worn over moth and nose; additional features may be found at https://www.remm.nlm.gov/respiratory_ppe.htm on Mar. 9, 2021. In some embodiments and elastic facepiece covers a user's face. A negative pressure mask respirator may be used with filters, cartridges, or canisters that are configured to remove certain types of contaminants.

While negative pressure mask respirators provide respiratory protection to the user they do not necessarily meet the Centers for Disease Control and Prevention's (CDC) guidelines for source control due to the lack of filtration on the exhalation valve of the respirator.

### BRIEF DESCRIPTION OF THE DRAWINGS

FIG. 1 depicts some embodiments of the invention, which shows some embodiments of a face piece, exchangeable filter element, environmental airflow device, an exhaust pipe with outflow/exhaust tube(s) to direct respiratory exhaust into PPE (Source Central), an outflow/exhaust valve, with the exit opening directed into PPE, wherein the outflow/exhaust tube attachment point may be downstream from the outflow/exhaust valve.

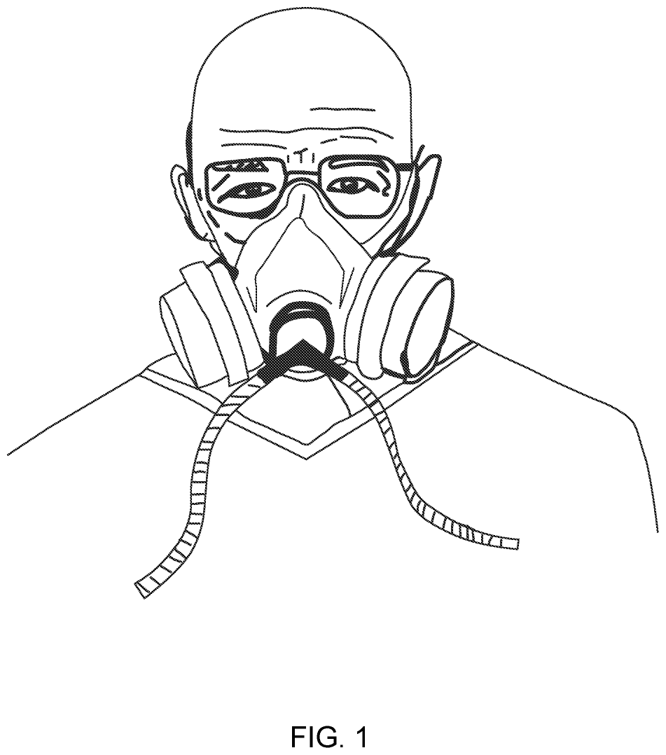

FIG. 2 depicts some embodiments of a negative pressure, half-mask, tight fitting, respirator with exhaust tube(s), directing exhaust into torso PPE;

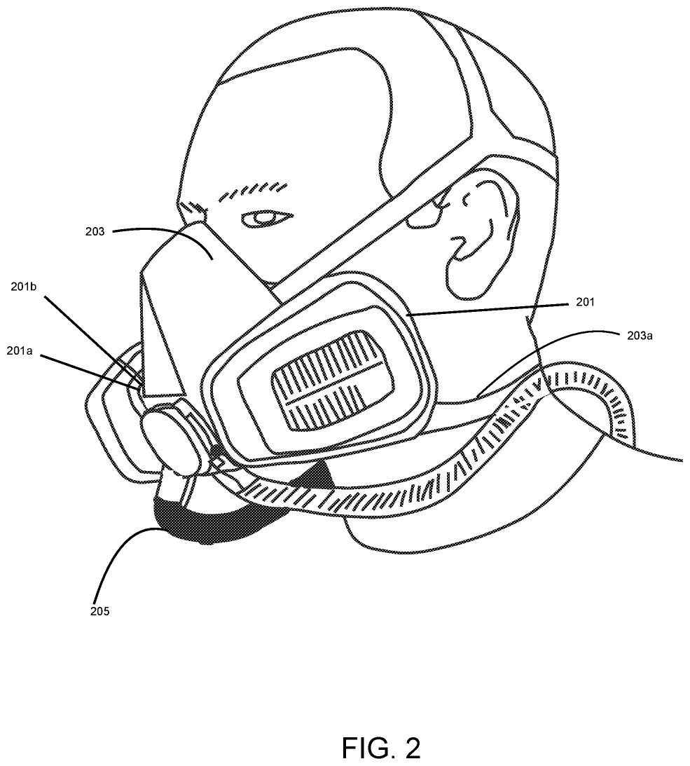

FIG. 3 depicts some embodiments of a negative respirator half mask with an exhaust conduit directing respiratory exhaust to required torso PPE; wherein the respirator may have an outflow/exhaust tube conduct that may facilitate the use of torso PPE as a filter/isolation/containment for respiratory exhaust (a shirt or other type of garment worn by the user may have an holder for the tube whereas the holder is not depicted in FIG. 3).

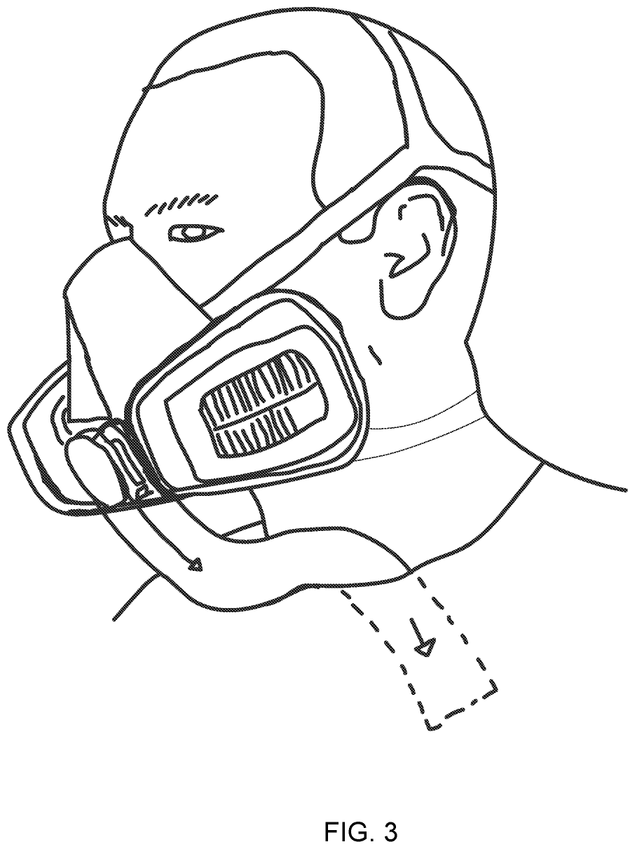

FIG. 4 depicts some embodiments of a negative pressure respirator full mask having exhaust conduits directing respiratory exhaust to the back of required torso PPE;

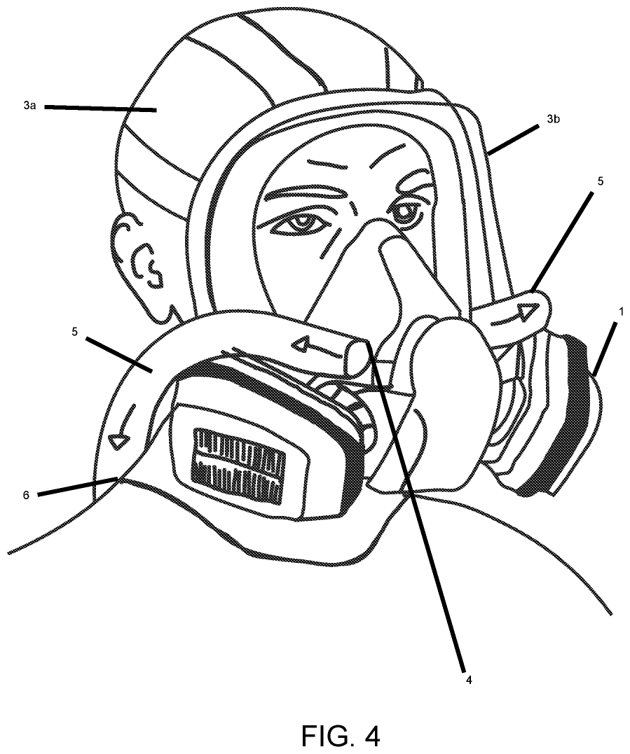

FIG. 5

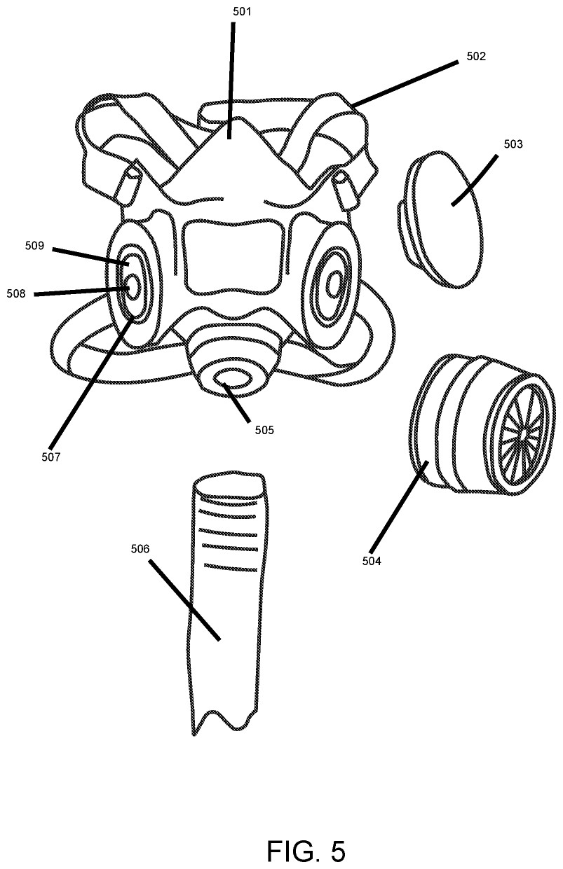

### SUMMARY OF THE INVENTION AND DETAILED DESCRIPTION

This invention is an improvement to existing negative pressure respirators, by adding a outflow/exhaust tube that may be coupled to the exhaust valve at a first end; the outflow/exhaust tube may be corrugated; the outflow/exhaust tube may have a second end or more through which exhaust may exit the outflow/exhaust tube.

The application discloses a method of utilizing the users required torso PPE as a safe and effective way to isolate or contain the users respiratory droplets and aerosols from the work area, operating table, or a patient that is positioned below the users face.

When wearing a negative pressure respirators, a user may lower a diaphragm, thereby generating negative pressure and negative pressure is created inside an interior compartment of the mask, which results in an intake valve opening and allowing atmospheric air to enter the interior compartment of the mask. When a user exhales, then a positive pressure is created inside the interior compartment of the mask, thereby closing the intake valve and opening at least one outflow/exhaust valve.

The invention may include:

1. Exchangeable filter elements that may include an
a. Attachment point that may be an attachment portion;
b. Airsealing gasket;

2. Intake valve(s)

3. Facepiece body that may include a
a. Headband/strap;
b. Faceshield;

4. Outflow/exhaust valve(s);

5. Outflow/exhaust tube directly coupled or indirectly coupled to the outflow/exhaust valve(s) (in some embodiments, the outflow/exhaust valve(s) may be coupled to one or more housings:

6. Outflow conduit that directs the exhaust in a direction, such as parallel to the user's torso and down the user's shirt, or down or into the user's PPE, or such as over the user's shoulder

Additional description about the elements of the invention:

1. Exchangeable filter elements: Selected to provide the needed protection:
a. Attachment point:
b. Airseal, gasket:

2. Intake valve(s): in some embodiments, provides one way flow of air through exchangeable filter elements and into the facepiece body.

3. Facepiece body: The foundation for all parts of synthetic or natural rubber material to form tight seal around the nose and mouth.
a. Headband/strap(s): Attach to facepiece body, top and bottom of facepiece body, wrap around user's head. The headband/strap may be useful for creating a tight-fitting seal between the facepiece body and a user's face.
b. Faceshield, which may be included in a full mask embodiment;

4. Outflow/exhaust valve(s):

5. Outflow/exhaust tube attachment point, which may enclose one or more outflow exhaust valve.

6. Outflow/exhaust tube(s), that may attach to the facepiece body downstream of the one-way outflow/exhaust valve. Directs respiratory exhaust into torso PPE.

7. Outflow conduit directing exhaust into torso PPE utilizes the user's required torso PPE as a safe and effective way to isolate or contain the user's respiratory droplets and aerosols

Quick connect connectors may be used for ease of attachment of various components.

Some of the tubes may have a connecting material such as Velcro.

In some embodiments, to reduce the humidity of outflow, an evaporative sponge or gauze may be disposed in a tube or at the end of the tube, or outside the tube; in some embodiments, a moisture trap, having a closeable opening, may be disposed in a tube or at the end of the tube, or outside the tube, and moisture may be removed a syringe, such as a Luer-lock syringe or syringe connects into a fitting. A Luer lock syringe enables a needle to be twisted onto the tip and be locked into place, providing a secure connection and preventing accidental removal of the needle as well as accidental injection of contents. In some embodiments, a clam shell device holding at least one 4×4 sterile gauze.

1. An apparatus comprising
an exchangeable filter elements;
at least one intake valve;
a facepiece body comprising a headband and a face shield;
an outflow valve;
an outflow tube coupled to the outflow valve;
the outflow tube directing exhaust in at least one direction selected from the group consisting of parallel to the user's torso and down the user's shirt, into the user's personal protective equipment, and over the user's shoulder.
